(19) United States
(12) Patent Application Publication
(10) Pub. No.: US 2015/0047551 A1
(43) Pub. Date: Feb. 19, 2015

(54) BELL FOR A BICYCLE

(71) Applicant: Stefan Christopher BUXTON, (US)

(72) Inventor: Stefan Christopher Buxton, London (GB)

(21) Appl. No.: 14/376,516

(22) PCT Filed: Feb. 1, 2013
(86) PCT No.: PCT/GB2013/050223

§ 371 Date: Aug. 4, 2014

(30) Foreign Application Priority Data
Feb. 3, 2012 (GB) 1201865.1
Jan. 17, 2013 (GB) 1300864.4

(51) Int. Cl. G10K 1/26

(52) U.S. Cl. CPC G10K 1/26
USPC 116/148; 29/428

(57) ABSTRACT

A bell for a bicycle including a body portion (12) with a stem (23) for supporting a bell casing (10). The body portion/bell casing is able to be adjusted to at an angle from the handlebars H of a bicycle such that a cyclist can more conveniently access hammer element (16) with a thumb from underneath without the bell housing hindering the free movement of the gear and/or brake mechanism.

### TECHNICAL FIELD

The present invention relates to a bell for a bicycle as is commonly used as a warning signal to pedestrians or other road users.

### BACKGROUND ART

A conventional bicycle warning bell (or simply hereinafter referred to as a “bell”) is usually mounted onto bicycle handlebars between the brake (and/or gear) mechanism and the handlebar stem. The space between the brake mechanism and the distal end of the handlebar is reserved for a rubber hand grip (hereinafter referred to as a “handlebar grip”) and optional bar end.

In normal use, the hands of a cyclist grip the handlebar grip with fingers being used to actuate the brake (and also gear mechanism in certain types of “lever” or “rapid fire” gear shifters) with a thumb gripping the underside of the handlebar grip where it is also able to actuate the opposing gear mechanism. Variations of this normal use are based on the type of gear mechanism.

In order to actuate a bell when it is in its conventional position on the upside of the handlebar (by applying pressure to the bell hammer with thumb or other finger), the cyclist must move their hand from gripping the handlebar grip to allow the thumb to reach the bell hammer. This movement reduces or eliminates both the cyclist's ability to apply pressure to the brake lever to slow the bicycle down, and their ability to maintain control of the bicycle with only a single hand gripping the handlebar grip. This is unsafe.

Given that bells need to be sounded to alert other road users, including pedestrians and cars, as to the presence of the cyclist in order to avoid a potential collision it would follow that the cyclist would prefer to concurrently maintain control of their bicycle with both hands, to actuate both brakes simultaneously (to prevent a skid or ejection over the front wheel) and to sound their bell to warn other road users.

Therefore a need has been identified for improvement to the current design and placement of bells.

Particularly, it is noteworthy that under UK law new bicycles must be sold with a bell, but this item is not commonly well integrated with the bicycle. It is typical for a bell to be included as an afterthought and, therefore, the position and operation of the bell is far from optimal.

Previous bell designs have made some attempt at integration or improved position. For example US2010/0236469A1 describes a bicycle bell integrated with the brake housing. However, this requires total replacement of the brake lever housing for a proprietary housing in order for the bell to be fitted to a bicycle handlebar.

GB263720 from 1927 described an integrated bell and mirror configuration. This design utilises a ball joint to give flexibility for positioning the mirror on a handlebar, but the bell trigger is not conveniently accessible. Furthermore, the trigger must actuate, via a wire, the bell ringing mechanism located at a distance from the handlebars, inside the combined mirror/bell housing/body.

### DISCLOSURE OF THE INVENTION

The present invention seeks to address existing bell design and placement leading to an overall improvement in safety.

In a broad aspect the present invention provides a bell for a bicycle comprised of:
a bell mounting body portion including:
   a hammer element attached by a resilient bias to the body portion;
   a stem to support a bell casing; and
   a joint portion associated with a handlebar mounting portion that is mountable with or extends from a circumference of the handlebars of the bicycle;
wherein said joint portion enables the bell mounting body portion to be angularly adjustable relative to handlebars of the bicycle.

When constructed the stem is enclosed by the bell casing.

Preferably the hammer element is attached to the body portion to be accessible by the thumb of a cyclist underneath a horizontal plane of the handlebars of a bicycle once installed. In practice, the adjustable installation freedom of the bell relative to the handlebars, in at least a pitch and yaw direction, enables a cyclist to more conveniently access the hammer with a thumb without the bell body portion hindering the free movement of gear and/or brake mechanisms of the bicycle. Future embodiments of the invention may provide for access to the hammer above the horizontal plane of the handlebars, either instead of but most preferably in addition to underneath access.

Preferably the bell casing is elongate. Most preferably the bell casing is bullet shaped.

Preferably the resilient bias is either a leaf spring (which may be integrally moulded with the body and hammer) or a torsion spring. In the case of a torsion spring the hammer and body are separate components connected by a suitable joint that is able to be biased by the torsion spring in order to “cock” the hammer and release it for ringing the bell that is mounted adjacent. However, with regard to a resilient member, any kind of spring or equivalent means (e.g. rubber band) could be employed.

Preferably, the hammer strikes the bell perpendicularly (from around a base of the body portion) to the bell, i.e. along the same axis but in an opposite direction to the cyclist's thumb movement). The hammer movement is generally perpendicular to the (longitudinal) axis of the bell, and within the same plane as a circular cross section of the bell. Many traditional bells are struck in parallel (from base to tip) and/or via an internal striking mechanism.

In a further broad aspect the present invention provides a bell for a bicycle including an elongated bell housing/casing extending from a handlebar mounting means. A hammer for striking the bell may move along a longitudinal axis of the elongate bell, circumferentially or radially.

As in the first aspect, preferably the housing, by virtue of the mounting means, is configurable to adjustably extend angularly from the handlebars. In such a way the angle of the elongated bell housing is adjustable for improved access of the hammer by the thumb of a user. In this preferred form the bell has two degrees of movement. A further form of the invention may feature a third degree of movement where the spatial distance between the bell housing and handlebars can be adjusted. A suitable sliding/extendable mechanism could be incorporated or a spacer element could be provided between the handlebar mount ring and the joint at the body portion.

Preferably the mounting means includes a loop to encircle the handlebars of a bicycle. Preferably there is tightening means wherein tightening of the loop also sets in place the adjusted (radial) angle of the bell housing.

In a yet further aspect of the invention there is provided a method of installing a bell according to the other aspects wherein said bell is positioned between a brake and/or gear housing mounted on the handlebars and a distal end of the handlebars. Preferably the mounting means of the bell is positioned over the rubber hand grip of a handlebar. The striking/trigger means is to be accessible by a thumb of a user from underneath the handlebars when the bell is mounted and adjusted.

It should be noted that where the present description refers to a cyclist, it can also refer to the operator of any other vehicle to which a bell could be fixed including baby carriages, push chairs, trolleys, wheelchairs and motorised carts.

### BRIEF DESCRIPTION OF THE DRAWINGS

FIGS. 1 to 4 illustrate side, plan, front and rear views of a bell according to the invention;

FIG. 5 illustrates a frontal perspective view of a bell according to the invention installed on a bicycle handlebar;

FIGS. 6 and 7 illustrate underneath plan views of a bell installed onto rapid fire and grip shift gear mechanisms respectively;

FIGS. 8 to 10 illustrate operation of a bell according to the invention;

FIG. 11 illustrates a general view of a bell according to a second embodiment of the invention mounted on handlebars of a bicycle;

FIG. 12 illustrates an exploded view of the components of a bell according to the invention;

FIG. 13 illustrates a rear exploded view of the components;

FIG. 14 illustrates an assembled rear view of the components of the invention;

FIG. 15 illustrates a side elevation exploded view; and

FIG. 16 illustrates a side elevation assembled view.

### MODE(S) FOR CARRYING OUT THE INVENTION

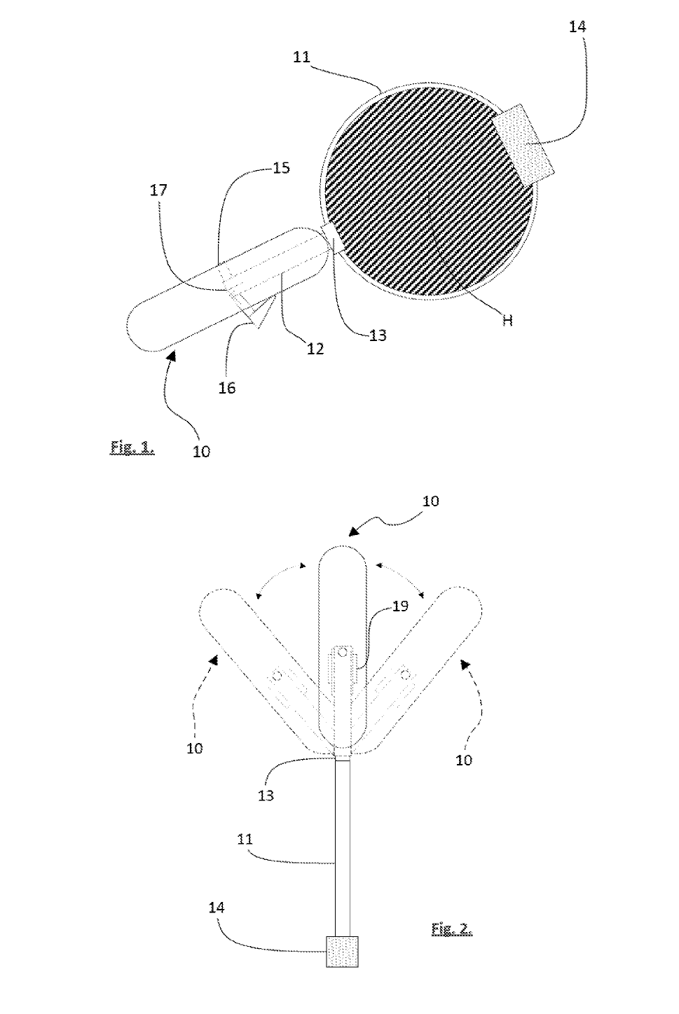

FIGS. 1 to 5 best illustrate the general components of a bell for a bicycle according to the invention, namely an elongate bell casing/housing 10 arranged to extend from a handlebar mounting means which, in the illustrated form, includes a fixing band 11. The bell includes a bell mounting body portion, in this case a bell arm 12 which is attached at a pivot point 13 to the fixing band 11, enabling the bell arm 12 and its surrounding housing 10 to be adjusted for yaw movement (see ghost outlines of housing 10 in the plan view FIG. 2).

In the illustrated form it is intended that, as the fixing band 11 is tightened onto a handlebar, the pivot 13 will become fixed (i.e. by withdrawing into a tube part or the like).

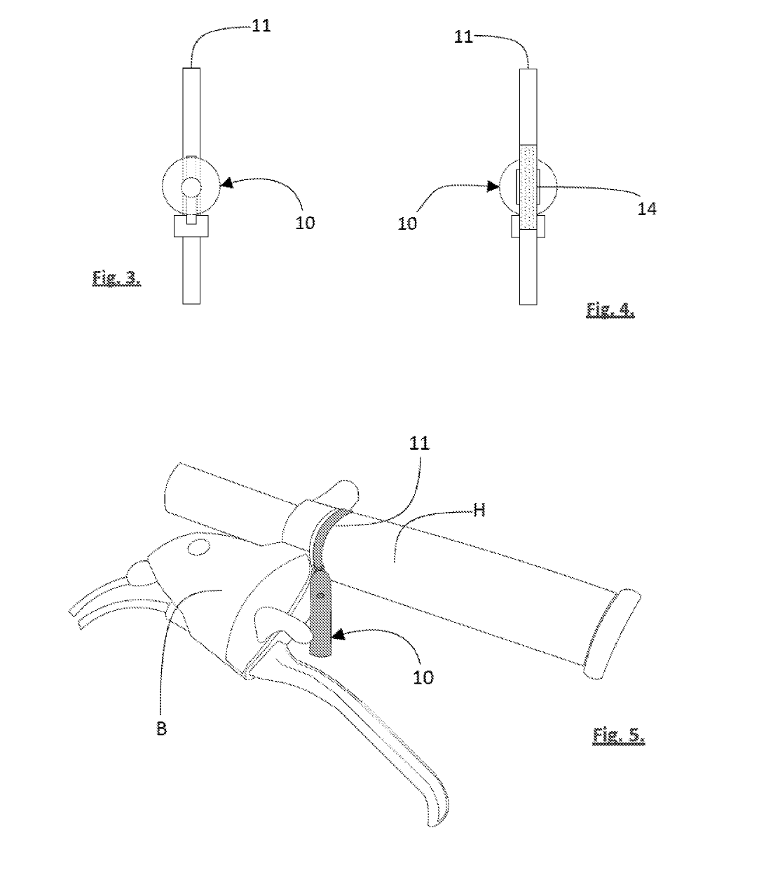

A mechanism for tightening the fixing band 11 is denoted by box 14 and is likely to be a screw operated ratchet or equivalent means. The fixing band 11 itself allows adjustable movement of the bell housing in the pitch direction around a handlebar H such that, overall, the bell housing has yaw and pitch adjustment for the comfort and accessibility of a user until it is fixed in place by tightening of the fixing band 11. FIG. 5 illustrates a position where the bell housing 10 is angled slightly downward (below the plane of the handlebar H) and away from the brake/gear housing B.

Referring back to FIG. 1, bell arm 12 is enclosed by housing 10 and these components are fixed together by a flange 15 which otherwise allows the housing freedom to vibrate and “ring” on its mounting (the arm 12). The bell sound is activated by a spring loaded hammer 16 pivotally connected at one end 17 to the bell arm 12. Further detail is provided by reference to FIGS. 8 to 10 described below.

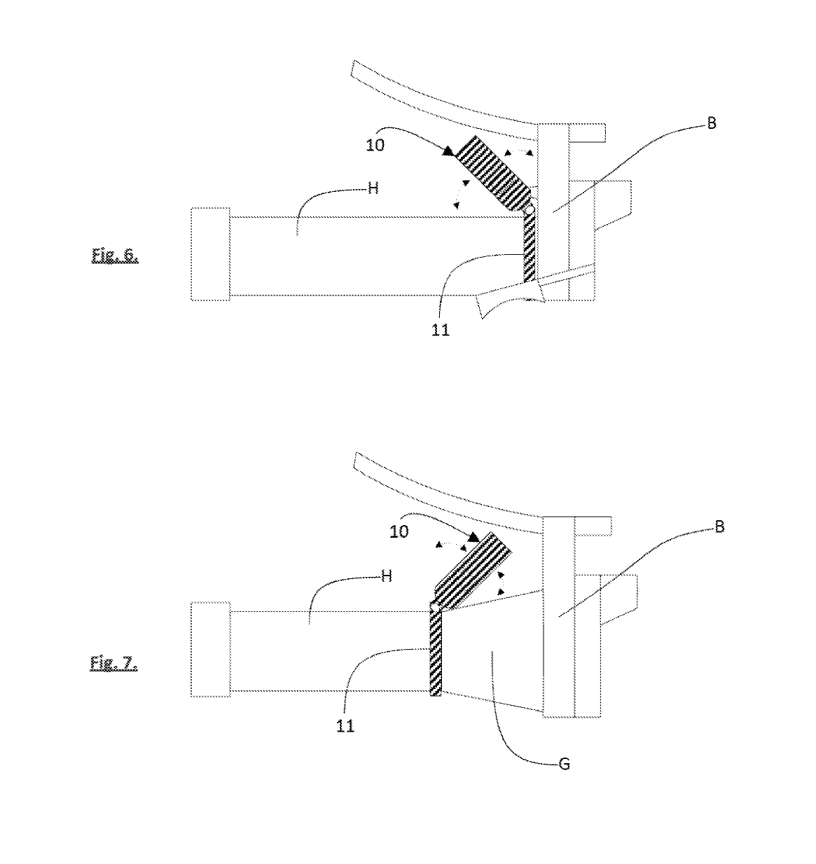

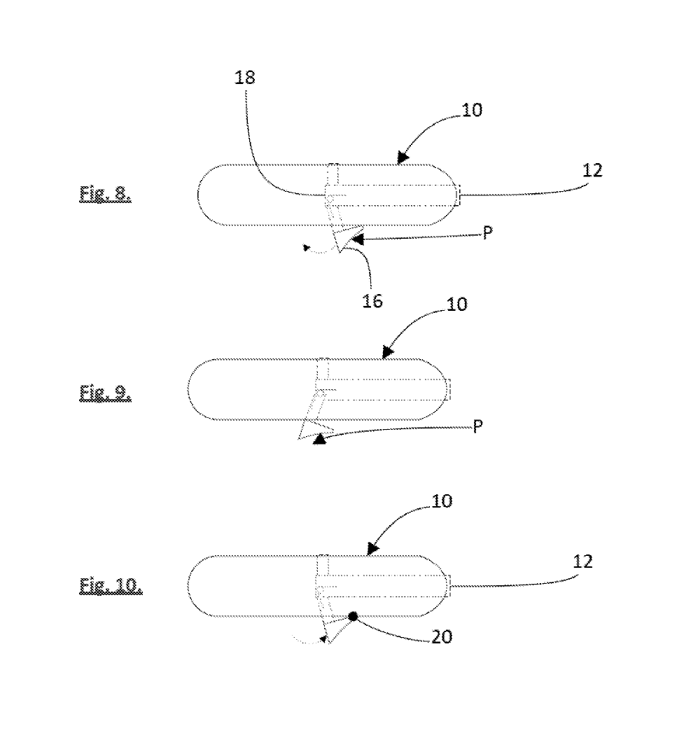

FIGS. 6 and 7 illustrate potential installation of the bell of the invention onto a rapid fire gear mechanism and grip shift gear mechanism respectively. Both figures show the underside of the right-hand handlebar of a bicycle but differ in that the bell 10 is angled away from the brake B in a rapid fire set-up (FIG. 6) and toward the brake B in a grip shift G set-up (FIG. 7).

It should be appreciated that, overall, the flexibility of the design allows a cyclist to adjust the angle of the bell arm to the handlebar prior to securing the bell to the handlebar H. The adjustment can be used to:

Ensure the bell arm/mounting body portion does not encumber the movement of any other bicycle components, such as the brake lever;

Ensure comfortable and easy access to the hammer 16 by the cyclist, e.g. by a thumb which is typically in a gripping position underneath the handlebar;

Allow the bell to be fixed to either the left or right hand side of the handlebar.

It is intended that external surfaces of the bell arm 12 and pivot 13 and internal surface of the handlebar fixing band 11 are textured. The bell arm 12 is positioned to the required angle by the cyclist before the handlebar fixing mechanism is engaged. When the handlebar fixing mechanism is engaged it secures the handlebar fixing band to the handlebar grip and the joint of the bell arm is also pressed against the rubber handlebar grip. The textured surface secures the bell arm to the desired angle without needing additional components.

FIGS. 8 to 10 illustrate operation of a bell 10 according to the first illustrated embodiment of the invention and show that the hammer 16 is fixed to the bell arm 12 by means of a torsion spring 18. The spring 18 runs along part of the length of the bell arm 12 and partly along the length of the hammer 16. The hammer 16 extends out from the bell through an aperture/slot 19 (FIG. 2) a distance from either end of the bell. This permits the bell to be longer than would otherwise be permitted by a traditional bell design where the trigger is fixed to the end of the bell. Flexibility in the length of the bell permits greater options for the sound dynamics of the bell.

The hammer 16 is angled such that when a cyclist's thumb applies a specific level of pressure P (FIG. 8) it will draw back and then naturally slip off the hammer (FIG. 9) allowing it to spring back and strike the bell at point 20 (FIG. 10).

In traditional bells (such as a bell installed with a lever grip or thumb grip) the hammer is not angled such that when the cyclist applies pressure to the hammer the thumb has to be drawn away to release the hammer to strike the bell. This is important as in situations when the cyclist needs to use the bell they will not be impeded by having to manoeuvre their thumb away from the hammer in order to release it but rather maintain one single natural motion to enable the bell to be sounded.

It should be noted, according to FIG. 8, that the resting position of the primary hammer is touching the bell.

It is also noteworthy that the hammer 16 is relatively short and relies on a powerful torsion spring 18 to strike the bell housing 10. This is significant in that the entire bell can be narrower for a lower profile and therefore more versatile for fitting into existing gear/brake lever arrangements. In general, an elongate bell casing means that the volume of the bell can be the same as conventional (round) bells, but with a much smaller diameter (“footprint”) to enable convenient positioning around other components.

It can be appreciated that variations on the bell design are possible within the scope of the invention. For example the hammer trigger for the bell may be located at the end of the elongated housing 10, distant from its pivot fixing point 13. The bell may also be a hollow tube suitably mounted on the bell arm.

A further modification may include mounting a bell at the end of an elongated bell arm, angularly mounted from the handlebar mounting means. In this sense it is the accessibility of the bell trigger/hammer by a user's thumb which is an important aspect of the invention, while not interfering with existing components on a bicycle.

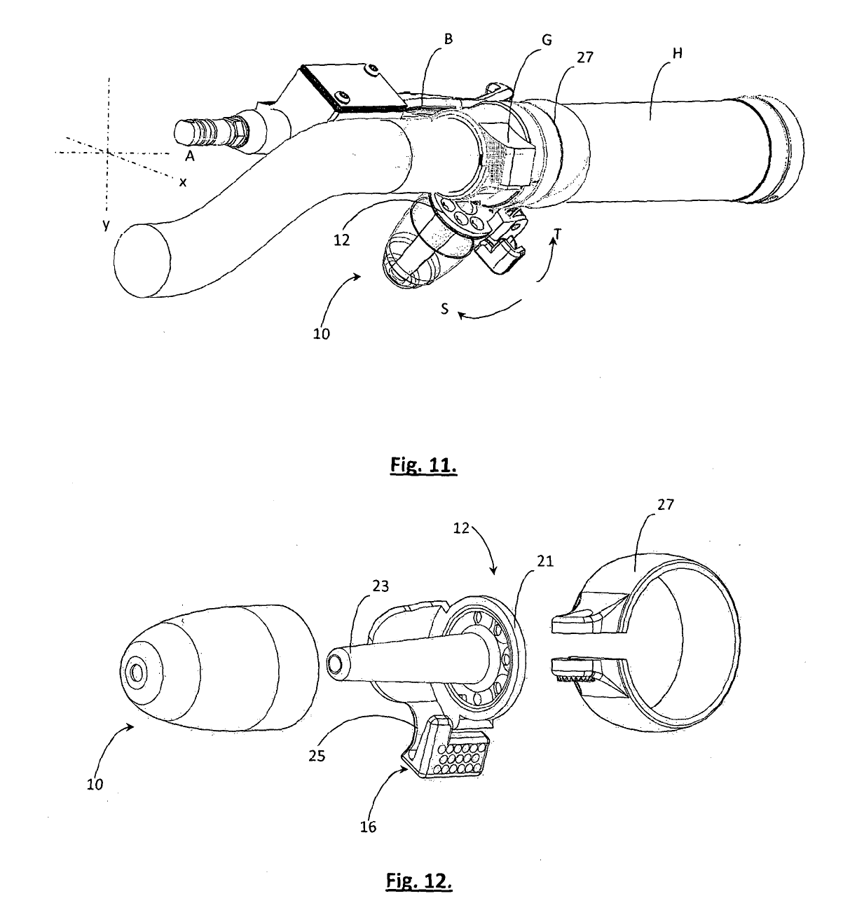

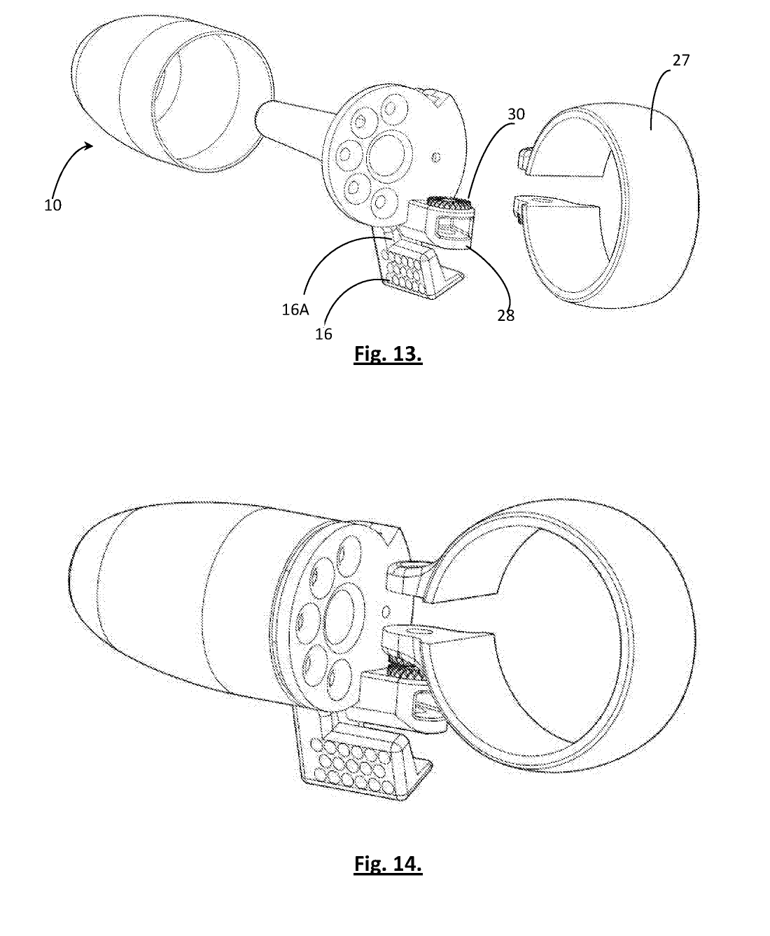

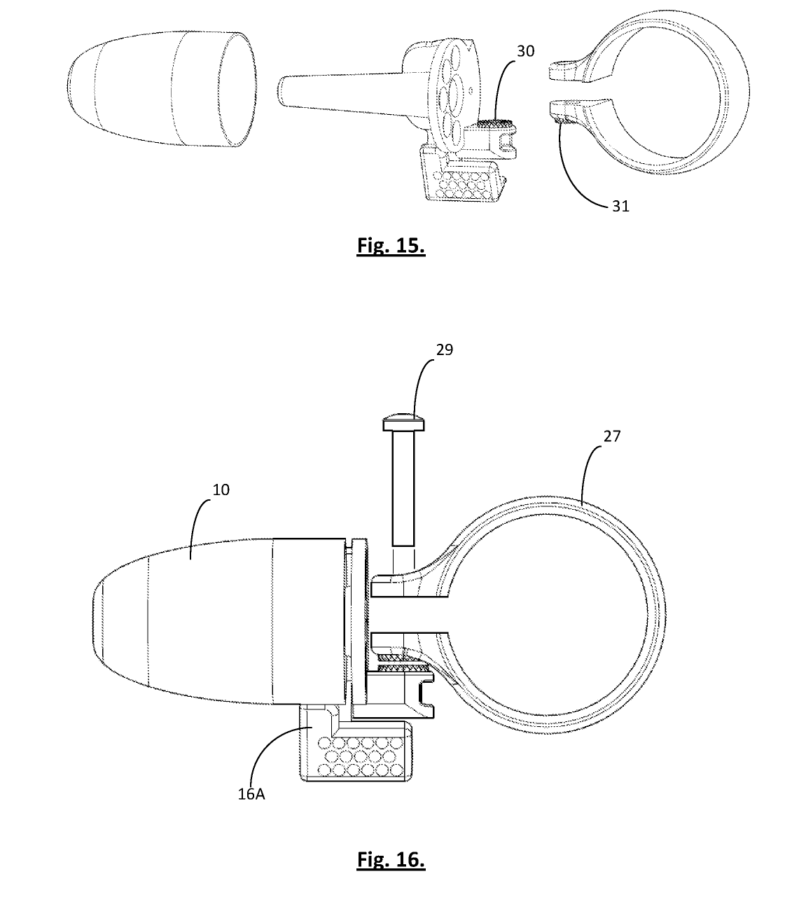

A most preferred embodiment of a bell for a bicycle according to the invention is illustrated by FIGS. 11 to 16, which incorporates some of the modifications mentioned above.

FIG. 12 best illustrates the general components of a bell according to the present invention, namely a bell mounting body portion 12 that includes a circular base 21 with a forward sweeping side wall or flange 22 at a peripheral edge and a centrally extending stem 23 (coaxial with the circular base). Furthermore, a hammer element 16 extends from the side wall 22 via a leaf spring 25. It will be apparent that the bell mounting body portion component can be moulded in one piece from a suitable material, e.g. plastic, to meet both the required resilience/flexibility of the leaf spring portion and a hardened area (16A) for the hammer 16 where it will strike the bell.

A bullet shaped bell casing 10 is shown in FIG. 12 that is mounted onto the stem 23 and substantially fixed in place (e.g. by screw or rivet) via an opening communicating with the stem.

FIG. 12 also illustrates a handlebar mounting portion 27 which is a loop provided to encircle the handlebars of a bicycle (see FIG. 11). Such a mounting means is relatively conventional; however, an open end of the handlebar mounting portion 27 is connected to a joint portion 28 of the bell mounting body portion 12, best illustrated in FIG. 3. Connection between the components does not need to be at the open end of the ring 27, but this is convenient because a single bolt 29 can provide a tightening force for both the ring to the handlebar and to set an offset yaw angle for the bell housing, as will be described hereinafter.

The handlebar mounting portion 27 is assembled with joint portion 28 via a bolt 29 as shown in FIG. 6. A mating toothed surface 30/31 is provided on the contacting face of the joint portion 28 and handlebar mounting portion 27 respectively. This enables a desired angle between the handlebars and body portion to be adjusted and fixed in place by the bolt 29. Alternative forms of elbow joint are possible, such as a ball joint.

Referring to FIG. 11, the handlebar mounting portion 27 enables the body portion 12 to be located at any desirable position extending radially from the handlebars H of a bicycle. This degree of freedom for mounting a bell is well known; however, the additional freedom of movement provided by the joint portion 28, adjustable about the axis of bolt 29, enables the bell to be located at an angular disposition relative to the handlebars and offset from a right angle relative to the handlebar surface. This additional degree of flexibility/customisation enables a cyclist to find a position which is most comfortable for access by a thumb or finger of the hammer element 14 for ringing the bell. Preferably the bell, and particularly hammer 16, are located underneath the plane A-x of the handlebar or grip so that a thumb can easily manipulate hammer 16.

As best seen in FIG. 12, the hammer element 16 is attached to the upstanding flange wall 22 of the body portion by a resilient bias provided by leaf spring 25. In use, a cyclist will push back the hammer 16 with a thumb in the direction of arrow T (FIG. 11) against the spring bias of leaf spring 25. Upon release, hammer 16 springs back toward its rest position and a few millimetres beyond where a striking end 16A of the hammer 16 contacts the bell casing 10, thereby ringing the bell in a familiar way.

It is intended that the bell casing 10 is manufactured from aluminium or any other suitable treated metal that has the requisite resonant properties for acting as a bell.

Modifications to the illustrated embodiments are possible, while retaining the general advantages of the invention. For example, it is possible that the handlebar mounting portion 27, to be connected to the joint portion 28, could be integrated into a handlebar assembly (e.g. a rubber sleeve or the like) which is not necessarily provided as a kit with the bell of the invention. However, as illustrated, the most convenient method of mounting the invention is to utilise a ring shaped handlebar mounting portion 27 that can surround a handlebar or hand grip. Hand grips are typically made from rubber or a foam material that can be suitably compressed by the ring 17 for secure placement of the bell.

To clarify, a conventional bell mounted via a ring similar to 27 enables a degree of flexibility in the radial direction of the handlebars, but it does not enable a pivoting sideways (yaw) adjustment relative to a fixed point on the handlebar (see FIG. 11).

The bell embodiment of FIGS. 11 to 16 is preferably installed outboard of the braking device B and/or gear controller G mounted on the handlebars H, similarly to the embodiment of FIGS. 1 to 10.

### INDUSTRIAL APPLICABILITY

As previously mentioned, the preferred material of the bell mounting body portion is plastic because the same material can be moulded to have resilient/flexible properties when thin or very hard with increasing thickness. The bell casing itself must have properties to enable sound to be produced. This is likely to be a suitable metal such as aluminium.

1. A bell for a bicycle comprised of:
a bell mounting body portion including:
a hammer element attached via a resilient bias to the body portion;
a stem to support and be substantially enclosed by a bell casing; and
a joint portion associated with a handlebar mounting portion that is mountable with or extends from a circumference of the handlebars of the bicycle;
wherein said joint portion enables the bell mounting body portion to be angularly adjustable in a yaw direction relative to handlebars of the bicycle.

2. The bell for a bicycle according to claim 1 wherein the hammer element is attached to the body portion so as to be accessible, in use, by a thumb of a user underneath a horizontal plane of the handlebars of the bicycle.

3. The bell for a bicycle according to claim 1 wherein the resilient bias spring.

4. The bell for a bicycle according to claim 3 wherein the spring is a leaf spring moulded with the body portion, an extension spring or a torsion spring biasing a joint between the hammer element and body portion.

5. The bell for a bicycle according to claim 1, wherein the hammer element is arranged for striking the bell with an arc of movement around the surface of the bell casing.

6. The bell of claim 5 wherein the hammer extends at a base end of the body portion and is contactable to an open end of the bell casing.

7. The bell for a bicycle according to claim 1 wherein the bell casing is elongate.

8. The bell for a bicycle according to claim 1 wherein the bell casing has a circular cross section.

9. The bell for a bicycle according to claim 1 wherein the bell casing is bullet shaped.

10. The bell according to claim 1 wherein the handlebar mounting portion includes a loop for encircling the handlebars of a bicycle.

11. The bell according to claim 10 wherein there is a tightening means for tightening of the loop.

12. The bell according to claim 11 wherein the tightening means also sets in place an adjusted angle of the bell arm.

13. The bell according to claim 1 wherein the hammer element extends pivotally from the stem through an aperture in the bell casing.

14. A method of installing a bell according to claim 1 wherein said bell is positioned between a brake and/or gear housing and/or associated levers mounted on the handlebars and an outboard end of the handlebars.

15. The method of claim 14 wherein the mounting means of the bell is positioned over the rubber hand grip of a handlebar.

16. The method of claim 14 wherein the hammer element is accessible underneath a plane of the handlebars when installed.

17. A bicycle incorporating a bell, the bell including:
a hammer element attached via a resilient bias to a body portion; and a stem to support and be enclosed by a bell casing;
the body portion/stem/bell casing being set at a yaw angle relative to handlebars of the bicycle bell and positioned between a brake and/or gear housing and/or associated levers mounted on the handlebars and an outboard end of the handlebars;
wherein the hammer element is accessible by a thumb of a user in a position underneath the handlebars.

18. The bicycle incorporating a bell of claim 17 wherein the hammer element is arranged to strike perpendicular to the bell casing.
